(19) United States
(12) Patent Application Publication
(10) Pub. No.: US 2005/0241544 A1
(43) Pub. Date: Nov. 3, 2005

(54) Fine discarding aggregate surfactant

(76) Inventor: Jui-Hsin Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/833,020

(22) Filed: Apr. 28, 2004

(51) Int. Cl. C04B 14/38; C04B 40/00

(52) U.S. Cl. 106/819

(57) ABSTRACT

The improved fine discarding aggregate surfactant is a metal chloride mixing solution. The metal chloride mixing solution has a first mixing solution with an alkali metal chloride and a second mixing solution with an alkaline-earth metal chloride with a two-valences metal chloride. The improved fine discarding aggregate surfactant can increase the connecting ability between the cement and the fine discarding fine aggregate. A formed cement structure can be used for an engineering construction material. Also, the fine discarding aggregate can be recycled and re-used.

### BACKGROUND OF THE INVENTION

1. Field of the Invention

The present invention relates to an improved fine discarding aggregate surfactant. It can increase a connecting ability between cement and fine discarding aggregate, so as to increase strength of a complex material. The complex material matches an engineering construction system's standard and is used in environmental and material recycling fields.

2. Description of Related Art

Recently, the combined ability of cement and fine discarding aggregate is studied and constructed actively by engineering constructed factories. The skill of combined ability is related to interfacial improvement, specific chemical reaction and using high affinity cement or similar components of cement. The skill of combined ability is suitable for various kinds of construction engineering fields, so as to reduce the cost and meet environmental requirements. For example, an improved surfactant can be used with recycled glass pellets to form a complex material that avoids wasting useless glass pellets. Presently, useless volcano rock doesn't match the efficient improved surfactant so that the volcano rock cannot be used as a construction material. Use of an efficient improved surfactant mixed into the volcano rock allows use of the same as a construction material. The field of low load ability needs many environmental construction materials like bricks for park pavement, artificial fish reefs and sidewalk bricks. Recently, improved fine discarding aggregate surfactant is widely used for construction material so that its components are developed and studied by many engineering factories. More particularly, the improvement of improved fine discarding aggregate surfactant is an increase in combination strength and a cheaper cost.

Taiwan Patent Number 00387866, “cement mixing substance for reinforcing the re-caving damage” is a prior art improved surfactant. The improved surfactant is composed of a first solution and a second solution. The first solution is selected from the group consisting of alkali metal chloride, alkali metal bromide an alkali metal borate. The second solution is selected from the group consisting of alkaline-earth mental chloride, alkaline-earth mental bromide, nickel chloride, copper chloride, manganese chloride, zinc chloride, nickel bromide, copper bromide, manganese bromide and zinc bromide. The weight ratio of the first solution to the second solution is 10:1 to 1:1. Although the prior art improved surfactant has good efficiency, it is too expensive and not used by factories when manufacturing large quantities of environmental building materials. According to above description, seeking a cheaper, improved surfactant is important. Furthermore, the high load ability material must meet many requirements so manufacturing a construction material with a higher load ability is also important.

A new improved surfactant must have a high combination ability of fine discarding aggregate, a proper ratio of chemical components for high load materials and a economic price. The present invention aims to resolve the problems in the prior art.

### SUMMARY OF THE INVENTION

The primary object of the present invention is to provide an improved fine discarding aggregate surfactant whose ratio of chemical components is economical and used for high load materials like sidewalk bricks, park building material and artificial reefs. The improved fine discarding aggregate surfactant is cheaper and high quality.

For reaching above objective, the improved fine discarding aggregate surfactant is improved and studied in light of the prior art surfactant. More particularly, regulating the ratio of metal chloride and precisely defining the ratio of components will develop a practical, useful surfactant.

In this invention, the improved surfactant of discarding fine aggregate is composed of a metal chloride mixing solution. The metal chloride mixing solution has a first mixing solution composed of an alkali metal chloride and a second mixing solution composed of an alkaline-earth metal chloride with a two-valences metal chloride. The two-valences metal chloride is selected from the group consisting of nickel chloride, copper chloride, manganese chloride and zinc chloride. A weight ratio of the first mixing solution to the second mixing solution is 1:1 to 1:3 or 10:1 to 15:1. The metal chloride mixing solution is added into a fine discarding aggregate with a cement to improve the connecting ability therebetween.

These and other objectives of the claimed invention will no doubt become obvious to those of ordinary skill in the art after reading the following detailed description of the preferred embodiments.

### DETAILED DESCRIPTION OF PREFERRED EMBODIMENTS

Reference is made to the following description, which is contains a chemical principle and experimental data. In this invention, a surface of fine aggregate has chemical binding pores, which can bind with various kinds of metal chloride to produce chemical bonds between fine aggregate and cement to increase the load strength of a cement structure.

Because the surface of fine aggregate has a space for linking ionic bonds, like silicon oxidized sites, it can bind with cement to support a fine discarding aggregate in cement. As a result, fine discarding aggregate does not form fragile pores in the cement structure. The generation of chemical bonds makes the fine discarding aggregate join with cement to form one body so that the load strength of the cement structure is strengthened.

If the cement is merely mixed with the fine discarding aggregate to form a cement structure, the cement structure will have fragile pores so that the cement structure is weak. When a large force is applied to the cement structure, it may break.

### (1) An Embodiment for Economizing Cost

In this embodiment, improved fine discarding aggregate surfactant is composed of the following components: sodium chloride concentration is 42 g/L; potassium chloride concentration is 97 g/L; magnesium dichloride concentration is 45 g/L; calcium dichloride concentration is 45 g/L; barium dichloride concentration is 28 g/L; nickel dichloride concentration is 19 g/L; and manganese dichloride concentration is 7 g/L. According to above ratios, the total alkali metal quantity of sodium chloride and potassium chloride is 139 g/L. The total quantity of alkali metal with other two-valences metal chloride, including magnesium dichloride, calcium dichloride, barium dichloride, nickel dichloride and manganese dichloride, is 144 g/L. The weight ratio of total alkali metal to total alkali metal with other two-valences metal chloride is 1:1.04.

According to the above ratios, mixing an improved surfactant into fine aggregate of glass pellets with cement forms an improved material and the improved material has higher load ability than a material not containing the improved surfactant. The material not containing the improved surfactant is only composed of glass pellets and cement. The load strength of the improved material is 3100 to 4000 psi. The improved material is cheaper because the use of expensive alkali metal is less than in the prior art and the cost of alkaline-earth metal is cheap. The improved material is used for engineering material of low load ability.

### (2) An Embodiment of High Load Ability

In this embodiment, an improved fine discarding aggregate surfactant is composed of the following components: sodium chloride concentration is 67 g/L; potassium chloride concentration is 196 g/L; magnesium dichloride concentration is 3 g/L; calcium dichloride concentration is 3 g/L; barium dichloride concentration is 10 g/L; nickel dichloride concentration is 7 g/L; and manganese dichloride concentration is 2 g/L. According to above description, total alkali metal quantity of sodium chloride and potassium chloride is 263 g/L. Total quantity of alkali metal with other two-valences metal chloride, including magnesium dichloride, calcium dichloride, barium dichloride, nickel dichloride and manganese dichloride, is 25 g/L. The weight ratio of total alkali metal to total alkali metal with other two-valences metal chloride is 10.5:1.

According to the above ratios, mixing the improved surfactant into a fine aggregate of glass pellets with cement forms an improved material and the improved material has higher load ability than the improved material of the first embodiment. The load strength of improved material of the second embodiment is 5500 to 6500 psi. The improved material of the second embodiment is more expensive because the use of expensive alkali metal is more than in improved material of the first embodiment. The improved material of the second embodiment is used for engineering material of high load ability.

In this invention, the improved fine discarding aggregate surfactant is composed of a metal chloride mixing solution. The metal chloride mixing solution has a first mixing solution composed of an alkali metal chloride and a second mixing solution composed of an alkaline-earth metal chloride and a two-valences metal chloride. The two-valences metal chloride is selected from the group consisting of nickel chloride, copper chloride, manganese chloride and zinc chloride. A weight ratio of the first mixing solution to the second mixing solution is 1:1 to 1:3 or 10:1 to 15:1. The metal chloride mixing solution is added into a fine discarding aggregate with a cement to improve connecting ability therebetween.

Furthermore, the alkali metal chloride is selected from the group consisting of sodium chloride and potassium chloride and the alkaline-earth metal chloride is selected from the group consisting of magnesium dichloride, calcium dichloride and barium dichloride. The metal chloride mixing solution is composed of sodium chloride, potassium chloride, magnesium dichloride, calcium dichloride and barium dichloride. The fine discarding aggregate has a surface of silicon oxidized bonds. The fine discarding aggregate is a volcanic rock pellet or glass pellet.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A improved surfactant of discarding fine aggregate, comprising:
a metal chloride mixing solution having a first mixing solution composed of an alkali metal chloride; and
a second mixing solution composed of an alkaline-earth metal chloride and a two-valences metal chloride;
wherein the two-valences metal chloride is selected from a group consisting of nickel chloride, copper chloride, manganese chloride and zinc chloride; and
wherein a weight ratio of the first mixing solution to the second mixing solution is about 1:1 to 1:3 or about 10:1 to 15:1; and
whereby the metal chloride mixing solution is added into a fine discarding aggregate with a cement to improve a connecting ability therebetween.

2. The improved surfactant of discarding fine aggregate in claim 1, wherein the alkali metal chloride is selected from a group consisting of sodium chloride and potassium chloride.

3. The improved surfactant of discarding fine aggregate in claim 1, wherein the alkaline-earth metal chloride is selected from a group consisting of magnesium dichloride, calcium dichloride and barium dichloride.

4. The improved surfactant of discarding fine aggregate in claim 1, wherein the metal chloride mixing solution is composed of sodium chloride, potassium chloride, magnesium dichloride, calcium dichloride and barium dichloride.

5. The improved surfactant of discarding fine aggregate in claim 1, wherein the fine discarding aggregate has a surface comprising silicon oxidized bonds.

6. The improved surfactant of discarding fine aggregate in claim 1, wherein the fine discarding aggregate is a volcanic rock pellet.

7. The improved surfactant of discarding fine aggregate in claim 1, wherein the fine discarding aggregate is a glass pellet.
